(19) United States
(12) Patent Application Publication
(10) Pub. No.: US 2003/0138081 A1
(43) Pub. Date: Jul. 24, 2003

(54) Switching center and method for forwarding status information

(76) Inventors: Thomas Burgard, Munich (DE); York Hochheim, Munich (DE); Axel Kreten, Puchheim (DE)

Correspondence Address: MORRISON & FOERSTER LLP, 1650 TYSONS BOULEVARD, SUITE 300, MCLEAN, VA, 22102, US

(21) Appl. No.: 10/203,291

(22) PCT Filed: Feb. 9, 2001
(86) PCT No.: PCT/DE01/00502

(30) Foreign Application Priority Data
Feb. 10, 2000 (DE) 100 05 788.8

(51) Int. Cl. H04M 1/64; H04M 11/00; H04M 3/42

(52) U.S. Cl. 379/88.22; 379/100.08; 379/211.01

(57) ABSTRACT

The invention relates to a switching center for switching communication links in a telephone network. The switching center comprises: a receiving device for receiving status information pertaining to the status of mailbox messages stored in one or more mailbox servers, whereby each item of status information contains at least one call number for conveying the respective item of status information to a corresponding terminal of the respective subscriber; a storage device for storing one or more additional call numbers of the respective subscriber which are stored in said storage device. The invention also relates to a corresponding method for forwarding status information. The invention makes it possible to easily and efficiently increase the level of accessibility of a subscriber to status information which indicates the status of the subscriber's mailbox.

The present invention relates to a switching center for switching communications connections in a telephone network, having a receiving device for receiving status information relating to the status of mailbox messages which are stored in one or more mailbox servers, with each status information item containing at least one telephone number for sending the respective status information to a corresponding terminal of the relevant subscriber. The present invention also relates to a method for passing on such status information.

The use of mailboxes for speech information, fax information, e-mail information and the like is becoming ever wider. Generally, mailbox messages such as these are in each case stored in a mailbox server, in which case the relevant subscriber for whom newly arriving mailbox messages are intended must either himself regularly check his mailbox messages, and call them up as required, or the subscriber is informed on his associated telephone terminal, such as a mobile telephone, a fixed apparatus at home or in the office, of the arrival of a new mailbox message by means of status information. Once a subscriber has been informed in such a way of a newly arriving mailbox message, he can retrieve it from the respective mailbox server and, for example, listen to it or display it on his telephone set, computer or the like.

By way of example, the “MWI” (Message Waiting Indication) service feature that is defined in the ETSI standard (European Telecommunications Standard Institute) supplies the status information that there is a new mailbox message only from a separate respective mailbox server (voicemail, fax mail, e-mail, etc). This status information is displayed on the terminal (analog telephone, ISDN telephone, mobile telephone or the like) as defined in advance by the subscriber. Depending on the display capability of the terminal and the signaling capability of the associated switching center to that terminal (analog telephone with additional signaling, for example by means of frequency shift keying FSK or an ISDN telephone with a functional protocol or stimulus protocol), the display may be simple, such as only “message waiting”, or more extensive, in which case, by way of example, the number of newly arrived mailbox messages, the arrival date and time, and the like are displayed.

The system as outlined above for automatic provision of status information relating to the status of mailbox messages has the disadvantage that the status information is in each case provided only on a single terminal for that subscriber. This severely restricts the accessibility of that subscriber, particularly if he is using a number of terminals, such as a mobile terminal, fixed telephone in his office and the like, at the same time.

The object of the present invention is thus to provide a switching center for switching communications connections in a telephone network as claimed in the pre characterizing clause of the attached claim 1, and a method for passing on status information relating to the status of mailbox messages which are stored in one or more mailbox servers, as claimed in claim 7, which allow the accessibility of a subscriber for the provision of status information to be improved in a simple and efficient manner.

This object is achieved by a switching center for switching communications connections in a telephone network having a receiving device for receiving status information relating to the status of mailbox messages which are stored in one or more mailbox servers, with each status information item containing at least one telephone number for sending the respective status information to a corresponding terminal of the relevant subscriber, having a memory device for storing one or more additional telephone numbers of subscribers, and a device for passing on an incoming status information item to one or more further telephone numbers, which are stored in the memory device, of the relevant subscriber.

The above object is also achieved by a method for passing on status information relating to the status of mailbox messages which are stored in one or more mailbox servers, with each status information item containing at least one telephone number for sending the respective status information to a corresponding terminal of the relevant subscriber, and with an incoming status information item being passed on to one or more telephone numbers of the relevant subscriber, which are stored in a memory device for storing one or more additional telephone numbers of subscribers.

The present invention thus provides a simple and efficient system for improving the accessibility of a subscriber for the status information items that are relevant to him. In particular, the use of a memory device, in which the additional telephone numbers are stored, in a switching center allows incoming status information to be diverted and passed on in a manner which is simple to implement but is nevertheless flexible. The subscriber need activate only the appropriate service feature or features in the switching center, so that there is no need for parallel administration in other devices. The relevant subscriber's terminal or terminals may be landline terminals, for example telephone sets at home or in the office, or else mobile terminals in a mobile radio system. The mailbox servers may provide mailbox messages in various message formats, for example speech information, fax information, e-mail information and the like.

The additional telephone numbers which are stored in the device advantageously define those terminals of the relevant subscriber to which a parallel call signal is passed on when an incoming call occurs. This means that the status information is passed on, in parallel to the “parallel call” service feature, to those terminals of the subscriber which also emit a parallel call signal when an incoming call occurs.

Alternatively, it may be advantageous for at least some of the additional telephone numbers which are stored in the memory device to define exclusively those terminals of the relevant subscriber to which an incoming status information item is passed on. In this case, the process of passing on and diverting incoming status information items is administered independently. The subscriber can himself and independently decide which of his terminals incoming status information items should be passed on or diverted to.

The telephone numbers which are stored in the memory device for a subscriber may advantageously be changed by the respective subscriber. For example, via a previously defined connection or an access code, the subscriber has the capability to change the telephone numbers which are stored in the digital switching center. This allows flexible adaptation of the accessibility to a subscriber.

When call diversion is activated, the device for passing on an incoming status information item advantageously diverts it to the telephone number which is defined by the call diversion. Thus, in this case, when the subscriber has activated call diversion, an incoming status information item is automatically passed on to the diversion destination terminal, based on the “call diversion” service feature. In this case, it may be advantageous for the device for passing on an incoming status information item when call diversion is activated to pass it on both to at least one of the at least one telephone number which is contained in the status information item and to the telephone number which is defined by the call diversion.

Advantageous refinements of the method according to the invention and claimed in claim 7 are specified in the respective dependent claims.

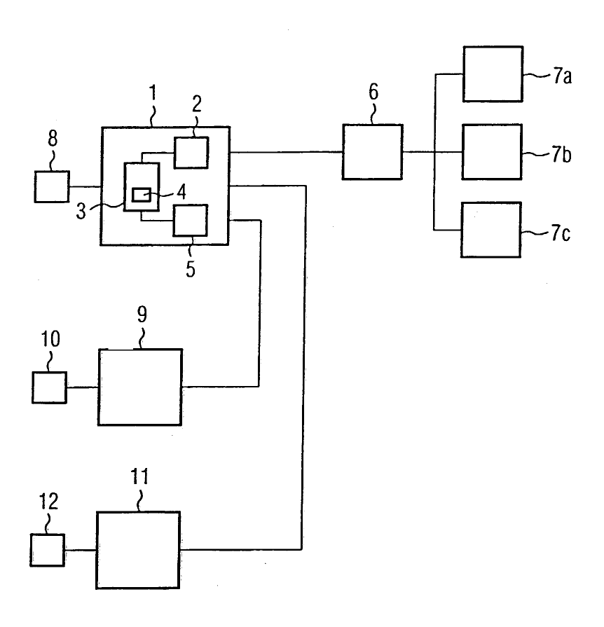

The present invention will be explained in more detail in the following text using a preferred exemplary embodiment and with reference to the single attached figure, FIG. 1. FIG. 1 shows, schematically, a communications system with a digital switching center 1 for switching communications connections in a telephone network and which may, for example, be an EWSD switching center. The digital switching center 1 has a receiving device 2 for receiving status information relating to mailbox messages which are stored in one or more mailbox servers 7a, 7b, 7c, with each status information item containing a telephone number for sending the respective status information to an appropriate predetermined terminal 8 of the relevant subscriber. The mailbox servers 7a, 7b, 7c may contain messages in various message formats, such as speech information, fax information, e-mail information and the like. The administration and central checking of the status information in the various mailbox servers 7a, 7b, 7c can be carried out, for example, via a central checking server 6, which thus collects the status information from the various mailbox servers 7a, 7b, 7c, adds a telephone number, and transmits to the switching center which is responsible for that subscriber an overall status information item relating to the status of all his mailboxes. This transmission process makes use, for example, of the signaling system No. 7, on the basis of the transaction capabilities application part (TCAP).

The digital switching center 1 contains a central control device 3 with a memory device 4 for storing one or more additional telephone numbers of subscribers. The memory device 4 may also be arranged externally to the control device 3. An incoming status information item for that subscriber with whom the terminal 8 which is connected to the digital switching center 1 is associated contains the telephone number of this terminal 8, so that the status information can be passed on directly to the terminal 8 by the digital switching center 1. If the subscriber wishes to activate an appropriate service feature for diverting/passing on status information, then he can store in the memory device 4 the telephone numbers of the corresponding terminals to which an incoming status information item should be passed on or diverted. When a status information item arrives in the receiving device 2, the control device 3 identifies the fact that the corresponding service feature is activated, and passes on the incoming status information in parallel to those telephone numbers of the relevant subscriber which are stored in the memory device 4. For example, in the situation shown in FIG. 1, incoming status information for the subscriber with whom the terminal 8 is associated is also passed on in parallel to the further terminals 10 and 12, which are respectively connected to the digital switching center 1 via a further switching center 9 and 12.

The terminals 8, 10 and 12 may be different telephone terminals, for example landline telephones, mobile telephones and the like. In the case of mobile telephones, the status information is preferably sent in the form of SMS (short message service) messages.

There are various possible ways for the digital switching center 1 to pass on or divert incoming status information. The first option is for the incoming status information to be additionally passed on only to those terminals which are also defined by the “parallel call” service feature. In this case, apart from being passed on to the terminal 8, an incoming status information item is also passed on to the other terminals which are defined by the subscriber and which would also emit a corresponding parallel call signal when an incoming call occurs. In this case, there is no need to define a specific memory device in the digital switching center 1 for passing on the status information, the same databank can be accessed which contains the terminals for the respective subscriber which are defined on the basis of the “parallel call” service feature.

A second option is to define a passing on and diversion of the status information completely autonomously. The subscriber has the capability to define telephone numbers to which incoming status information should be passed on or diverted separately or independently of other service features, and to store the telephone numbers in an appropriate manner in the memory device 4. In this case, a mixture of the first two options is feasible, in which, by way of example, the incoming status information is passed on not only to all the telephone numbers which are defined in the “parallel call” service feature, but also to further terminals.

Alternatively, or additionally to the options described above, incoming status information may also be diverted on the basis of the “call forwarding” service feature. In this case, an incoming status information item may be diverted, for example, exclusively to a telephone number which is defined by the call diversion and is stored in an appropriate manner in the memory device 4. However, in this case, in many situations it may be advantageous to pass on an incoming status information item in addition to that terminal whose telephone number is contained in the status information, such as the terminal 8. With present-day telephone systems, the “call diversion” service feature is subdivided into the “immediate call forwarding”, “diversion is there is no reply” and “forward if busy” service features. Actual passing of an incoming status information item exclusively to the telephone number which is defined in the call diversion advantageously takes place only for “immediate call forwarding”. In the case of “forwarding if there is no reply”, there is no knowledge at the time of an incoming status information item as to whether the relevant subscriber can see the status information on the originally intended terminal, such as the terminal 8, or whether he is located exclusively at the terminal for the forwarding destination. Thus, in this case, the status information should be displayed on both terminals. In the case of “forward if busy”, the status information may be displayed either exclusively on the busy terminal of the subscriber, or else on the busy terminal and at the forwarding destination. The simplest solution to implement is to provide an incoming status information item both at the originally intended terminal and at the forwarding destination terminal for all service features which relate to call diversion.

The present invention makes it possible to greatly increase the accessibility of a subscriber for incoming status information as a result of the capability to provide the status information in parallel at a number of terminals. In this case, in particular, the passing on or diversion of incoming status information on the basis of the “parallel call” and/or “call forwarding” service features allows a very simple and efficient implementation. Furthermore, the subscriber does not in this case need to carry out any extensive administration processes by making appropriate entries himself, but need only activate the desired service feature in the switching center. Since the checking server in each case sends the collected status information items to a single responsible switching center, this avoids parallel administration, and the status information is provided to the subscriber in a simple and effective manner. The improvement in the accessibility of the subscribers is achieved using PSDN means, such as an EWSD switching center, and can thus be used for any type of status information which effects a display on a telephone terminal.

1. A switching center (1) for switching communications connections in a telephone network, having a receiving device (2) for receiving status information relating to the status of mailbox messages which are stored in one or more mailbox servers (7a, 7b, 7c), with each status information item containing at least one telephone number for sending the respective status information to at least one terminal (8) of the relevant subscriber, a memory device (4) for storing one or more additional telephone numbers of subscribers, and a device (5) for passing on an incoming status information item to one or more further telephone numbers, which are stored in the memory device (4), of the relevant subscriber.

2. The switching center as claimed in claim 1, characterized in that the additional telephone numbers which are stored in the memory device (4) define those terminals of the relevant subscriber to which a parallel call signal is passed on when an incoming call occurs.

3. The switching center as claimed in claim 1, characterized in that at least some of the additional telephone numbers which are stored in the memory device (4) define exclusively those terminals of the relevant subscriber to which an incoming status information item is passed on.

4. The switching center as claimed in claims 1 to 3, characterized in that the telephone numbers which are stored for a subscriber in the memory device (4) can be changed by the respective subscriber.

5. The switching center as claimed in one of claims 1 to 4, characterized in that when call diversion is activated, the device (5) for passing on an incoming status information item passes it to the telephone number which is defined by the call diversion.

6. The switching center as claimed in one of claims 1 to 4, characterized in that, when call diversion is activated, the device (5) for passing on an incoming status information item passes it on to at least one of the at least one telephone number which is contained in the status information item, and at the same time passes it to the telephone number which is defined by the call diversion.

7. A method for passing on status information relating to the status of mailbox messages which are stored in one or more mailbox servers, with each status information item containing at least one telephone number for sending the respective status information to at least one corresponding terminal of the relevant subscriber, and
with an incoming status information item being passed on to one or more telephone numbers of the relevant subscriber, which are stored in a memory device for storing one or more additional telephone numbers of subscribers.

8. The method as claimed in claim 7, characterized in that the additional telephone numbers which are stored in the memory device define those terminals of the relevant subscriber to which a parallel call signal is passed on when an incoming call occurs.

9. The method as claimed in claim 7, characterized in that at least some of the additional telephone numbers which are stored in the memory device define exclusively those terminals of the relevant subscriber to which an incoming status information item is passed on.

10. The method as claimed in one of claims 7 to 9, characterized in that the telephone numbers which are stored for a subscriber in the memory device can be changed by the respective subscriber.

11. The method as claimed in one of claims 7 to 10, characterized in that, when call diversion is activated, an incoming status information item is passed to the telephone number which is defined by the call diversion.

12. The method as claimed in one of claims 7 to 10, characterized in that, when call diversion is activated, an incoming status information item is passed on to at least one of the at least one telephone number which is contained in the status information, and is at the same time passed to the telephone number which is defined by the call diversion.
